(19) United States
(12) Patent Application Publication
(10) Pub. No.: US 2025/0012396 A1
(43) Pub. Date: Jan. 9, 2025

(54) MULTILAYER SLEEVE HAVING THERMALLY INSULATIVE, FIRE SUPPRESSIVE, AND ELECTROMAGNETIC REFLECTIVE PROPERTIES FOR ELECTRIC VEHICLE COOLANT TUBE AND METHOD OF CONSTRUCTION

(71) Applicant: FEDERAL-MOGUL POWERTRAIN LLC, Northville, MI (US)

(72) Inventors: Cassie Marie MALLOY, Trappe, PA (US); Steven Mark GALAMBA, West Chester, PA (US)

(21) Appl. No.: 18/706,102

(22) PCT Filed: Oct. 28, 2022
(86) PCT No.: PCT/US2022/078840

§ 371 Date: Apr. 30, 2024

Related U.S. Application Data
(60) Provisional application No. 63/273,123, filed on Oct. 28, 2021.

(51) Int. Cl. F16L 57/04; B32B 1/08; B32B 5/02; B32B 15/08; B32B 15/14; B32B 27/12; H01M 10/613; H01M 10/625; H01M 10/656; H01M 10/658; H01M 50/383

(52) U.S. Cl. CPC F16L 57/04; B32B 1/08; B32B 5/024; B32B 15/08; B32B 15/14; B32B 27/12; H01M 10/613; H01M 10/625; H01M 10/656; H01M 10/658; H01M 50/383; B32B 2255/06; B32B 2255/10; B32B 2255/26; B32B 2262/101; B32B 2307/3065; B32B 2597/00; H01M 2220/20

(57) ABSTRACT

A protective sleeve for a battery pack coolant tube of an electric vehicle includes a tubular wall extending along a longitudinal axis between opposite ends. The tubular wall has multiple layers, including an innermost textile layer having filaments interlaced with one another and a composite outer layer overlying the innermost textile layer. The composite layer includes a foil layer and a fire resistant coating overlying the foil layer.

### CROSS-REFERENCE TO RELATED APPLICATION

This application claims the benefit of U.S. Provisional Application Ser. No. 63/273,123, filed Oct. 28, 2021, which is incorporated herein by reference in its entirety.

### BACKGROUND OF THE INVENTION

### 1. Technical Field

This invention relates generally to protective sleeves for protecting elongate members extending therethrough, and more particularly to multilayered sleeves for providing insulating, electromagnetic shielding, and thermal runaway protection to electric vehicle battery coolant tubes.

### 2. Related Art

While advancements have been made in electric vehicle battery packs, referred to hereafter as batteries, that allow them to deliver more power and require less frequent charges, one of the biggest challenges that remain for battery safety is the ability to design an effective cooling system and providing protection thereto that meets ever increasing safety focused requirements.

In electric cars, discharging the battery during use generates heat, and the more rapidly a battery is discharged, the more heat is generated. Batteries work based on the principle of a voltage differential, and at high temperatures, the electrons inside the battery become excited, which decreases the difference in voltage between terminals of the battery. Batteries are only capable of functioning between certain temperature extremes, and thus, if there is no cooling system to keep the battery in a working temperature range, it will not function as intended. Cooling systems generally need to be able to keep the battery pack in the temperature range of about 20-40 degrees Celsius, as well as keep the temperature difference within the battery to a minimum (generally no more than 5 degrees Celsius differential).

If there is a large internal temperature difference, it can lead to different charge and discharge rates for each cell of the battery pack and deteriorate the battery pack performance. Potential thermal stability issues, such as capacity degradation, thermal runaway, and fire explosion, could occur if the battery overheats or if there is non-uniform temperature distribution in the battery pack. In the face of safety enhancement, innovation is desired in the electric vehicle industry to improve the battery cooling system.

There are different approaches to cooling electric vehicle battery packs, namely, use of phase change materials, fins, air cooling, and liquid cooling, wherein liquid cooling has received the most attention. Liquid cooling systems can be divided into direct cooling systems, wherein the battery cells are in direct contact with a coolant, and indirect cooling systems, wherein a liquid coolant is routed through a series of tubes, wherein plastic tubes are receiving much attention for reduction of cost and weight purposes. Within these two systems, indirect cooling systems are more commonplace.

The coolant tubes, in order to provide maximum function, need to be insulated, while also being shielded from electromagnetic radiation, thereby possessing electromagnetically compatible (EMC) properties. Accordingly, it is known to wrap the coolant tubes with separate protective layers of material to attain the protection desired, wherein each of the separate protective layers is applied in a separate operation. Although such separate protective layers can prove effective in use, they are cumbersome and costly to apply. Further yet, it is desired to provide the protective layers being resistant to thermal runaway, thereby protecting the underlying plastic tubing against being melted in order to best prevent coolant from leaking from the coolant system.

Accordingly, it is desired to provide an easy to apply, single component in a single operation about the coolant tubes that is effective in serving multiple functions, including thermal insulation, EMC protection, and resistance to thermal runaway.

### SUMMARY OF THE INVENTION

In according with one aspect of the disclosure, a protective sleeve for a battery pack coolant tube of an electric vehicle is provided. The protective sleeve includes a tubular wall extending along a longitudinal axis between opposite ends. The tubular wall has multiple layers including: an innermost textile layer having filaments interlaced with one another and a composite outer layer bonded to the innermost textile layer with an adhesive layer. The composite layer includes a foil layer bonded to the adhesive layer: a first thermoplastic film bonded to the foil layer: a fire resistant coating bonded to the first thermoplastic film: a fiberglass scrim layer overlying the fire resistant coating, and a second thermoplastic film overlying the fiberglass scrim layer.

In accordance with another aspect of the invention, the innermost textile layer can be provided as a circumferentially continuous woven wall.

In accordance with another aspect of the invention, the woven wall has warp multifilaments extending generally parallel to the longitudinal axis and weft thermoplastic filaments extending generally transversely to the warp multifilaments, wherein the weft thermoplastic filaments are heat-shaped to retain the woven wall having a round shape as viewed in cross-section taken generally transverse to said longitudinal axis.

In accordance with another aspect of the invention, the multifilaments can be provided as fiberglass.

In accordance with another aspect of the invention, the composite outer layer is spiral wrapped about the innermost textile layer.

In accordance with another aspect of the invention, the fire resistant coating is one of a silicone, silicone-based, liquid silicone rubber, polytetrafluoroethylene, or polyurethane impervious coating.

In accordance with another aspect of the invention, the fire resistant coating is silicone rubber.

In accordance with another aspect of the invention, a protective sleeve for a battery pack coolant tube of an electric vehicle is provided, including, a tubular wall extending along a longitudinal axis between opposite ends, wherein the tubular wall has multiple layers. The multiple layers include: an innermost textile layer having filaments interlaced with one another: a foil layer bonded to the innermost textile layer; and a fire resistant coating bonded to the foil layer.

In accordance with another aspect of the invention, the fire resistant coating is one of a silicone, silicone-based, liquid silicone rubber, polytetrafluoroethylene, or polyurethane impervious coating.

In accordance with another aspect of the invention, the foil layer is bonded to the innermost textile layer with a pressure sensitive adhesive.

In accordance with another aspect of the invention, the foil layer is spiral wrapped about the innermost textile layer.

In accordance with another aspect of the invention, fire resistant coating is cured.

In accordance with another aspect of the invention, a protective sleeve for a battery pack coolant tube of an electric vehicle is provide, including, a tubular wall extending along a longitudinal axis between opposite ends, wherein the tubular wall has multiple layers. The multiple layers include: a first foil layer; a fire-resistant scrim layer overlying the first foil layer: a second foil layer overlying the fire-resistant scrim layer; a heat seal adhesive bonded to the second foil layer; a first thermoplastic film bonded to the heat seal adhesive; a fire resistant coating bonded to the first thermoplastic film: a fiberglass scrim layer overlying the fire resistant coating; and a second thermoplastic film overlying the fiberglass scrim layer.

In accordance with another aspect of the invention, the tubular wall is corrugated.

In accordance with another aspect of the invention, the fire resistant coating is one of a silicone, silicone-based, liquid silicone rubber, polytetrafluoroethylene, or polyurethane impervious coating.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a schematic perspective view of an electric vehicle having a battery pack with a cooling system having a coolant tube protected by a multilayered sleeve in accordance with the disclosure;

FIG. 2 is an enlarged schematic perspective view of the coolant tube shown being protected by a multilayered sleeve constructed in in accordance with one aspect of the disclosure:

FIG. 3 is a schematic cross-sectional view taken along a length of the sleeve generally along the line 3-3 of FIG. 2 illustrating the layers of the multilayered sleeve;

FIG. 3A is perspective view of an innermost textile layer of the multilayered sleeve of FIG. 3:

FIG. 4 is a view similar to FIG. 3 illustrating layers of a multilayered sleeve in accordance with another embodiment of the disclosure:

FIG. 5 is a view similar to FIG. 2 of a multilayered textile sleeve constructed in accordance with another aspect of the disclosure:

FIG. 6 is a schematic cross-sectional view taken along a length of the sleeve generally along the line 6-6 of FIG. 5 illustrating the layers of the multilayered sleeve:

FIG. 7 is a side view of a thermally insulative, electromagnetically compatible reflective convoluted sleeve constructed in accordance with one aspect of the invention shown disposed about an elongate member:

FIG. 8 is a cross-sectional side view taken generally along the line 8-8 of the sleeve of FIG. 7; and

FIG. 8A is a view similar to FIG. 8 of a sleeve constructed in accordance with another aspect of the invention.

### DETAILED DESCRIPTION OF PREFERRED EMBODIMENTS

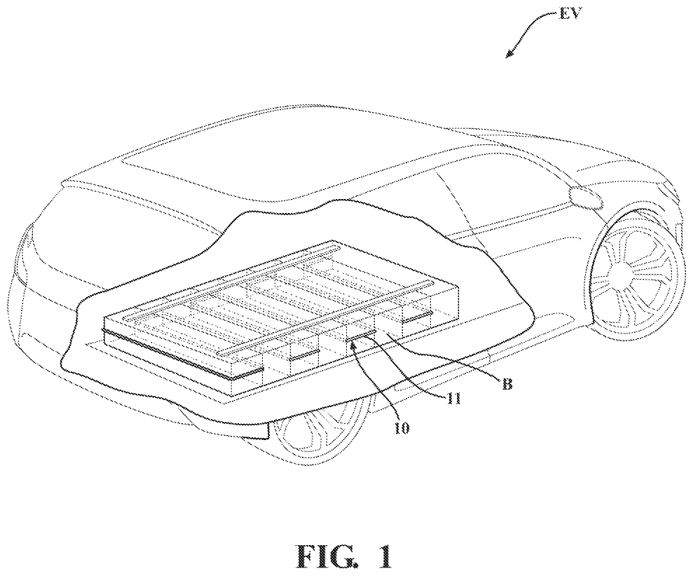

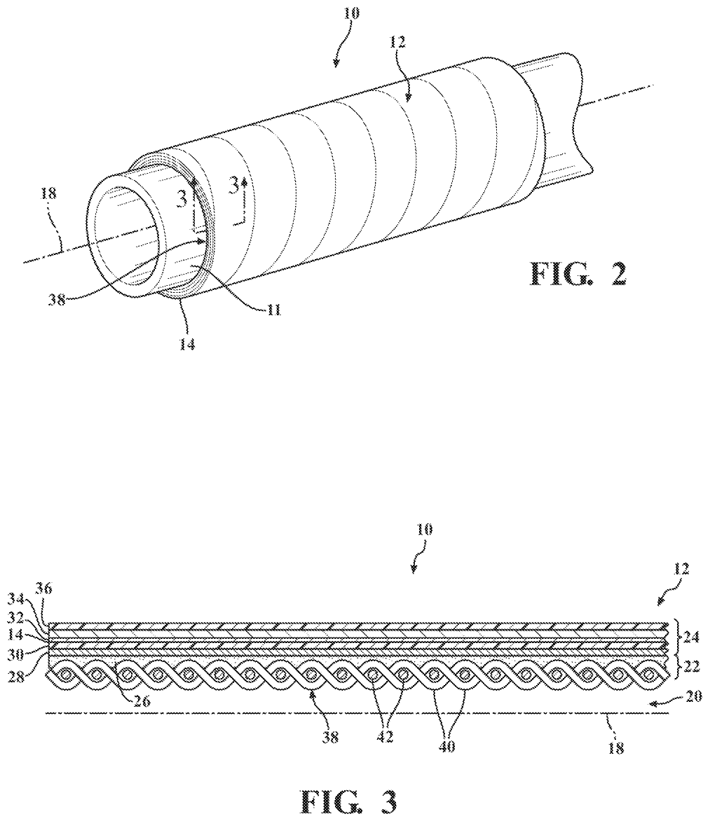

Referring in more detail to the drawings, FIG. 1 illustrates a battery pack coolant tube protective multilayered textile sleeve, referred to hereafter as multilayered sleeve or sleeve 10. The sleeve 10, as constructed in accordance with one aspect of the invention, has a multilayered tubular wall 12 disposed about an elongate member 11 to be insulated and protected, such as a battery pack coolant tube of an electric vehicle EV battery B (FIG. 1). The multilayered wall 12 of the sleeve 10 is constructed to be flexible and to keep the battery pack B in an optimal working temperature range of about 20-40 degrees Celsius, by way of example and without limitation, as well as keep the temperature difference within the battery pack B to a minimum (generally no more than 5 degrees Celsius differential). The multilayered wall 12 extends lengthwise between open opposite ends, with one end 14 illustrated, and about a central axis 18 to bound a central cavity 20, through which the elongate member 11 extends and in which the elongate member 11 is protected against at least: electrical interference from electrical waves in an external environment E, impact forces, such as may be experienced in a vehicle crash, abrasion, and ingress of contamination, by way of example and without limitation, and thermally against thermal runaway, such as from flame and/or hot gas.

The multilayered wall 12 has a plurality of layers, including an innermost textile layer 22 having filaments interlaced with one another and a multilayered, composite outer layer, referred to hereafter as composite layer 24, overlying the innermost textile layer 22. In accordance with an aspect of the disclosure, the composite layer 24 is bonded to the innermost textile layer 22, such as via an adhesive layer 26. The composite layer 24, as best shown in FIG. 3, includes a foil layer 28 bonded directly to a radially outwardly facing side of the adhesive layer 26, a first thermoplastic film 30 bonded directly to a radially outward facing side of the foil layer 28, a fire resistant coating 32 overlying the foil layer 28, and shown being bonded directly to the first thermoplastic film 30, a fiberglass scrim layer 34 overlying the fire resistant coating 32, and a second thermoplastic film 36 overlying the fiberglass scrim layer 34.

The innermost textile layer 22 bounds, and is openly exposed to the central cavity 20. As such, the elongate member 11 contacts an inner surface 38 of the innermost layer 22. The innermost textile layer 22 is formed as a circumferentially continuous wall, and can be constructed via a weaving, braiding, or knitting process. Accordingly, the innermost layer 22 is one of a woven, braided or knit tubular, seamless wall 22. The innermost layer 22 can be constructed using any desired yarn, whether monofilament and/or multifilament yarn, and in one exemplary embodiment, is constructed with multifilament fiberglass yarn 40, which provides an enhanced thermal insulation barrier, and thermoplastic yarn 42. The thermoplastic yarn 42 can be provided as monofilaments, wherein the fiberglass yarn 40 and the thermoplastic yarn 42 can be woven with one another. In a non-limiting example, the fiberglass yarn 40 can be woven in a warp direction extending in a lengthwise direction generally parallel to the central axis 18 and the thermoplastic yarn 42 can be woven in a circumferentially extending direction in a fill or weft direction generally transverse to the warp direction. The thermoplastic yarn 42 can be provided as a heat-settable thermoplastic yarn and heat-set about a mandrel to provide the innermost textile layer 22, and the wall 12, with a round shape as viewed in cross-section taken generally transverse to said longitudinal axis looking along the central axis 18, thereby permanently biasing the wall 12 to be generally cylindrical, and thus, facilitating assembly of the sleeve 10 on the elongate member 11.

The composite outer layer 24 can be spiral wrapped about the innermost textile layer 22, with the adhesive layer 26 bonding the composite outer layer 24 directly to the innermost textile layer 22. The adhesive layer 26 can be provided as a pressure sensitive adhesive, by way of example and without limitation.

The fire resistant coating 32 can be provided as one of a silicone, silicone-based, liquid silicone rubber, polytetrafluoroethylene, or polyurethane impervious coating.

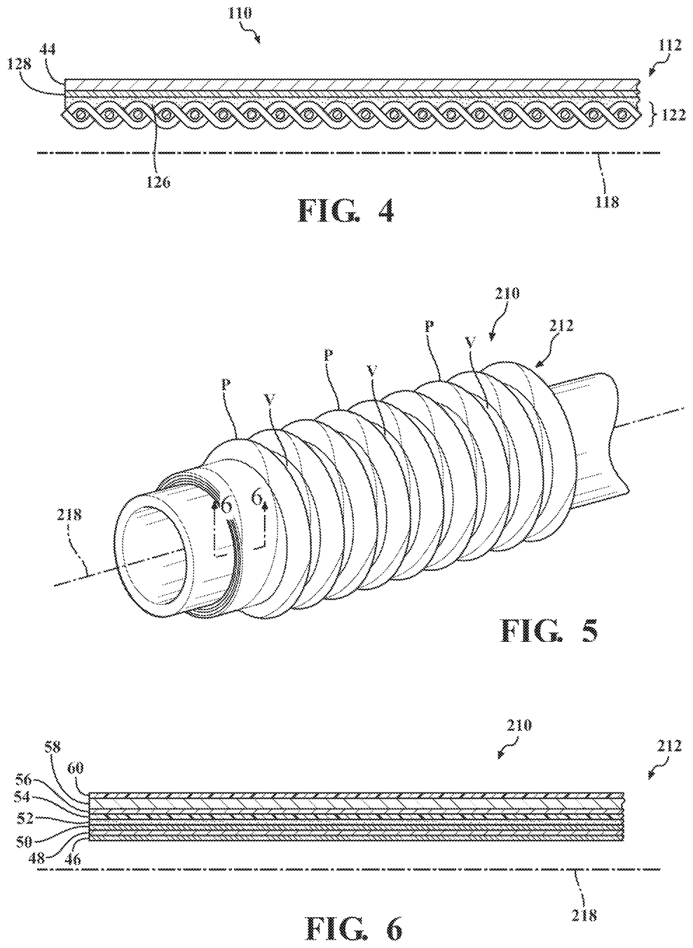

In FIG. 4, a sleeve 110 constructed in accordance with another aspect of the disclosure is shown, wherein the same reference numerals as used above, offset by a factor of 100, are used to identify like features.

The sleeve 110 has a multilayered wall 112 extending about a central axis 118. The wall 112 includes an innermost textile layer 122, wherein the innermost textile layer 122 is constructed as discussed above for the textile layer 22. However, rather than having a composite outer layer as discussed above, the wall 112 includes an adhesive layer 126, such as a pressure sensitive adhesive, and a foil layer 128 as discussed above, wherein the foil layer 128, with pressure sensitive adhesive layer 126 bonded thereto, can be spiral wrapped and bonded directly to the innermost textile layer 122 via the pressure sensitive adhesive. However, radially outward from the foil layer 128 the wall 112 only has a flame/fire resistant outermost coating 44 overlying the foil layer 128, and shown being applied and bonded to a radially outwardly facing surface of the foil layer 128. The fire resistant coating 44 is one of a silicone, silicone-based, liquid silicone rubber, polytetrafluoroethylene, or polyurethane impervious coating, whereupon applying the fire resistant coating 44 to the foil layer 128, the fire resistant coating 44 is cured.

In FIG. 5, a protective sleeve 210 for a battery pack coolant tube 11 constructed in accordance with another aspect of the disclosure is shown, wherein the same reference numerals as used above, offset by a factor of 200, are used to identify like features.

The sleeve 210 has a multilayered wall 212 extending about a central axis 218. As best shown in FIG. 6, the multiple layers of the multilayered wall 212 include: a first foil layer 46; a fire-resistant scrim layer 48 overlying the first foil layer 46; a second foil layer 50 overlying the fire-resistant scrim layer 48; a heat seal adhesive 52 bonded to the second foil layer 50; a first thermoplastic film 54 bonded to the heat seal adhesive 52; a fire resistant coating 56 bonded to the first thermoplastic film 54, wherein the fire resistant coating 56 is one of a silicone, silicone-based, liquid silicone rubber, polytetrafluoroethylene, or polyurethane impervious coating: a fiberglass scrim layer 58 overlying the fire resistant coating 56; and a second thermoplastic film 60 overlying the fiberglass scrim layer 58. Upon the layers being laminated with one another, the laminated layers can be wrapped about a mandrel to form the multilayered wall 212 as being a circumferentially continuous, spiral wrapped wall. Then, the resulting multilayered wall 212 can be upset (deformed) to attain a corrugated contour having peaks P and valleys V, and then heated sufficiently to cause the heat seal adhesive 52 to be activated to complete the construction of the flexible wall 212, wherein the flexibility and thermal protective properties are enhanced by the corrugations in the wall 212.

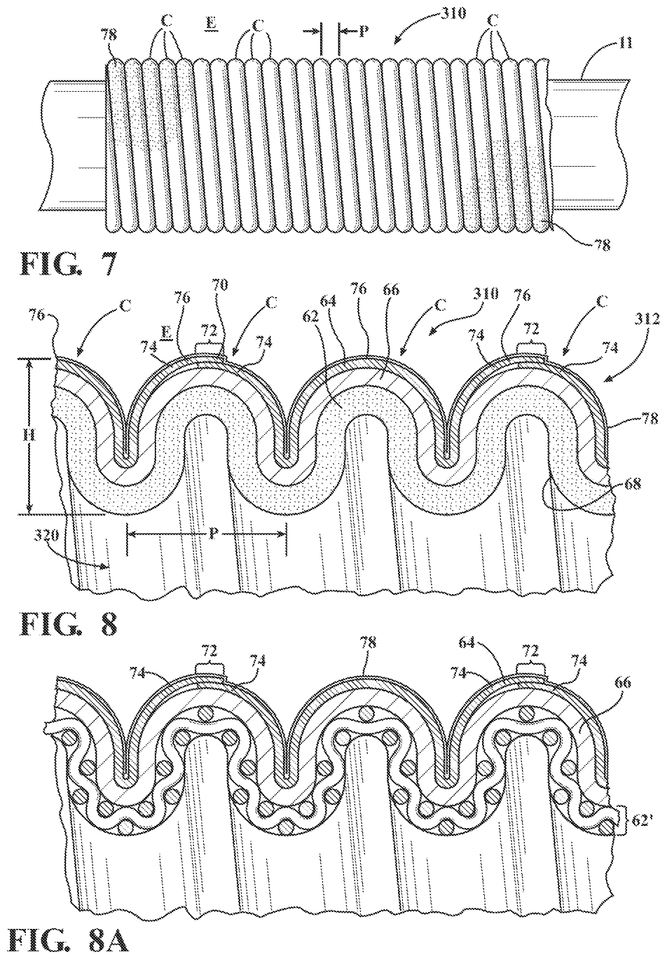

FIG. 7 illustrates a thermally insulative, electromagnetically compatible (protective), reflective corrugated sleeve 310, constructed in accordance with another aspect of the invention, for protecting an elongate member 11, such as a fluid or gas coolant conveying conduit (pipe), as discussed above. As best shown in cross-section of FIG. 8, the sleeve 310 includes a resilient wall 312 that may be crushed or otherwise compressed radially, and then resiliently spring back or return to its as constructed cylindrical, tubular configuration without compromising the protective physical properties of the sleeve 310. As such, the sleeve 310 retains is useful corrugated, cylindrical shape and functionality even if inadvertently radially crushed or compressed, such as in storage, during shipment, during routing or while in use. These properties of the wall 312 are provided by an innermost layer, also referred to as inner layer 62, an outermost layer, also referred to as outer layer 64, and an intermediate layer 66 sandwiched between the inner and outer layers 62, 64, wherein at least one or more, including all, of the layers 62, 64, 66 are resilient.

The inner layer 62 is constructed having an inner surface 68 exposed to and bounding an inner cavity 320 of the sleeve 210 and the outer layer 64 is constructed having a reflective outer surface 70 exposed to the surrounding environment E. The intermediate layer 66 is constructed of an imperforate, impervious sheet material and is sandwiched in abutment with both the inner and outer layers 62, 64. The inner, outer and intermediate layers 62, 64, 66 are convoluted to provide the wall 312 with corrugations, also referred to as convolutes C, immediately adjacent one another, thereby providing the sleeve 310 with an enhanced ability to be flexed and routed over meandering paths without becoming damaged or otherwise compromising the functionality of the sleeve 310. The convolutes C contribute to the improved thermal barrier properties of the sleeve 310 by effectively thickening the wall 312 in regions having folded portions of the convolutes C adjacent and abutting, or substantially abutting one another.

The inner layer 62 can be constructed from nonwoven fiber-reinforced material, such as a fiber-reinforced polymeric material, such as polyethylene terephthalate (PET), or from other types of fiber-reinforced materials, such as fiberglass, by way of example and without limitation. Otherwise, as shown in FIG. 8A, an inner layer 62′, constructed in accordance with another aspect of the invention, can be constructed as a tightly woven material layer, such as discussed above for textile layer 22, thereby being free or substantially free of holes.

The intermediate layer 66 is constructed from an imperforate, impervious polymeric film material. The polymeric film material can be provided as a biaxially-oriented polyethylene terephthalate, e.g. Mylar.

The outer layer 64 is constructed from a metallic foil material. The metallic foil material can be provided as a composite lamination, or as a single sheet of metallic material. The metallic foil material can include various types of metal, including steel, iron and/or aluminum. Regardless of the type of metallic material, the outer layer 64 is provided as a thin layer, thus allowing the outer layer 64 to be readily compressed, while thereafter returning to its original tubular configuration under the bias of the inner and intermediate layers 62, 66. The outer layer 64 is wrapped about the intermediate layer 66 and bonded to itself at overlapping regions 72, such as by being spiral wrapped. The outer layer 64 is coated on a radially inwardly facing surface with an adhesive prior to being wrapped, and thus the overlapping regions 72, upon coming into contact with one another, become adhere to one another via the coating material. However, remaining non-overlapped regions 74 of the outer layer 64 remain free and non-adhered from the intermediate layer 66 given its slick, non-adhesive properties. Accordingly, the outer layer 64 remains free to move relative to the intermediate layer 66 during use, thereby facilitating its remaining undamaged during application.

Upon applying the resilient outer layer 64 about the tubular construction of the inner and intermediate layers 62, 66, convolutes C are formed in the inner, outer, and intermediate layers 62, 64, 66 to provide the tubular configuration with an enhanced flexibility, insulative, and thermal barrier properties. The convolutes C are formed by passing the tubular wall 312 between an inner die and an outer die. The convolutes C can be formed in a tight configuration, thereby attaining a relatively increased number of corrugations per inch, and having a small pitch P, such that the crests 76 are formed immediately adjacent one another and in abutting or substantially abutting relation one another. As such, the abutting portions of the convolutes C can effectively thicken the wall height, thereby contributing the insulating, thermal barrier properties of the sleeve 310. As such, depending on the characteristics sought, the convolutes C and be formed as desired, including selecting the desired pitch P and height H. It should be recognized that during formation of the convolutes C, the outer layer 64 is free to slide slightly relative to the abutting intermediate layer 66, and thus, tearing of the thin outer layer 64 is prevented.

Then, upon forming the convolutes C, an outermost fire/flame resistant coating 78 is applied over the entirety of an outer surface of the outer layer 64, thereby providing the sleeve 310 with enhanced thermal runaway protection. The outermost fire/flame resistant coating 78 can be applied as a liquid, such as from a liquid coating of silicone, silicone-based, liquid silicone rubber, polytetrafluoroethylene, or polyurethane impervious coating, and subsequently cured.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A protective sleeve for a battery pack coolant tube of an electric vehicle, comprising:
a tubular wall extending along a longitudinal axis between opposite ends, said tubular wall having multiple layers including:
an innermost textile layer having filaments interlaced with one another; and
a composite outer layer overlying said innermost textile layer, said composite layer including a foil layer and a fire resistant coating overlying said foil layer.

2. The protective sleeve of claim 1, wherein said foil layer is bonded to said innermost textile layer.

3. The protective sleeve of claim 1, wherein said foil layer is bonded to said innermost textile layer with a pressure sensitive adhesive.

4. The protective sleeve of claim 2, wherein said fire resistant coating is bonded to said foil layer.

5. The protective sleeve of claim 4, wherein said fire resistant coating is one of a silicone, silicone-based, liquid silicone rubber, polytetrafluoroethylene, or polyurethane impervious coating.

6. The protective sleeve of claim 5, wherein said fire resistant coating is an outermost layer.

7. The protective sleeve of claim 6, wherein said fire resistant coating is cured.

8. The protective sleeve of claim 4, wherein said innermost textile layer is a circumferentially continuous wall.

9. The protective sleeve of claim 8, wherein said composite outer layer is spiral wrapped about said innermost textile layer.

10. The protective sleeve of claim 2, further including a first thermoplastic film bonded to said foil layer, wherein said fire resistant coating is bonded to said first thermoplastic film, and further including a fiberglass scrim layer overlying said fire resistant coating, and a second thermoplastic film overlying said fiberglass scrim layer

11. The protective sleeve of claim 10, wherein said innermost textile layer is a circumferentially continuous wall.

12. The protective sleeve of claim 11, wherein said innermost textile layer is a woven wall.

13. The protective sleeve of claim 12, wherein said woven wall has warp multifilaments extending generally parallel to the longitudinal axis and weft thermoplastic filaments extending generally transversely to the warp multifilaments, said weft thermoplastic filaments being heat-shaped to maintain said woven wall having a round shape as viewed looking along said longitudinal axis.

14. The protective sleeve of claim 13, wherein said multifilaments are fiberglass.

15. The protective sleeve of claim 10, wherein said composite outer layer is spiral wrapped about said innermost textile layer.

16. The protective sleeve of claim 10, wherein said fire resistant coating is one of a silicone, silicone-based, liquid silicone rubber, polytetrafluoroethylene, or polyurethane impervious coating.

17. A protective sleeve for a battery pack coolant tube of an electric vehicle, comprising:
a tubular wall extending along a longitudinal axis between opposite ends, said tubular wall having multiple layers including:
a first foil layer;
a fire-resistant scrim layer overlying said first foil layer:
a second foil layer overlying said fire-resistant scrim layer;
a heat seal adhesive bonded to said second foil layer;
a first thermoplastic film bonded to said heat seal adhesive;
a fire resistant coating bonded to said first thermoplastic film;
a fiberglass scrim layer overlying said fire resistant coating; and
a second thermoplastic film overlying said fiberglass scrim layer.

18. The protective sleeve of claim 17, wherein said tubular wall is corrugated.

19. The protective sleeve of claim 17, wherein said fire resistant coating is one of a silicone, silicone-based, liquid silicone rubber, polytetrafluoroethylene, or polyurethane impervious coating.

20. The protective sleeve of claim 17, wherein said fire resistant coating is cured.
